(19) United States
(12) Patent Application Publication
(10) Pub. No.: US 2007/0013935 A1
(43) Pub. Date: Jan. 18, 2007

(54) Printing information processing device, printing information processing method and printing information processing program

(75) Inventor: Yasuhiko Uchida, Nagano (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/480,160

(22) Filed: Jun. 30, 2006

(30) Foreign Application Priority Data
Jul. 1, 2005 (JP) P2005-193446

(51) Int. Cl. G06F 3/12

(52) U.S. Cl. 358/1.13

(57) ABSTRACT

A storage part stores the paper information defining the paper size and a first identifier corresponding to the paper information. An input part inputs a second identifier corresponding to the paper information. An information setting part reads the paper information associated with the first identifier matched with the second identifier from the storage part, based on the second identifier inputted by the input part, and outputs the paper size defined by the paper information.

### BACKGROUND OF THE INVENTION

The present invention relates to a print information processing apparatus, a print information processing method and a print information processing program.

In recent years, various printing apparatuses have spread which can print and output an image photographed by a photographing apparatus such as a digital camera by appropriately making an edit process, for example. Nowadays, of these printing apparatuses, a print job creation apparatus as a print information processing apparatus has been provided which can process a photographed image through various printing services using a template capable of editing the layout in the form of a preset post card or album and create a print job including the setting information for the print conditions through these printing services. In this print job creation apparatus, the processed image can be simply printed and outputted, based on the created print job, using a print output apparatus arbitrarily selected from among a plurality of print output apparatuses equipped at a photo shop.

This print job creation apparatus is configured in the following way. That is, in the print job creation apparatus, an output destination setting screen for setting an output destination apparatus, to which a print job being created or having been created in the form of a document is outputted for each printing service or each paper size, is configured in three stage setting columns, including an upper stage output destination setting column for setting the output destination apparatus, a middle stage paper kind setting column for setting the kind of paper used for printing, and a lower stage output process setting column for setting an output process in the creation process for the print job.

Also, in the output destination setting column, an apparatus or printer connected to a local network, or an apparatus or printer connected to a different network can be set up on a so-called pull-down menu displayed on the screen by a selection input operation of the user. And if an instruction of creating the print job or an instruction of executing the print job is made in the print job creation apparatus, its print job is outputted to the output destination apparatus setup in the output destination setting column, and the print related operation is shared (divided) among a plurality of apparatuses, whereby the print job is easily created or executed (e.g., refer to JP-A-2004-326586).

In the print job creation apparatus for providing various printing services as described above, an application installed beforehand in the apparatus for implementing various print related functions, with the information concerning the paper size suitable for each country or district defined inside the application, is provided to the photo shop, thereby improving the convenience in the actual uses. Also, when the paper other than the paper size supported beforehand for the print job creation apparatus by the application is used in the print output, the user can use the information such as actual dimensional values of the paper size as the user defined size by inputting it separately, thereby improving the universality of the apparatus.

However, in the above print job creation apparatus of the prior art, since the information concerning the paper size suitable for each country or district is defined beforehand inside the application, the application software having the information concerning the individual paper size for each country or district is required, when it is necessary to retrofit the application newly, increasing the steps or development costs for the retrofit, and often making it difficult to localize the print job creation apparatus inexpensively and simply.

Also, when the paper of the paper size not supported by the application is used for the print output, it is required that the user separately inputs the dimensional values of the paper size as the user defined size, possibly increasing the troublesome operations. Especially in the process for directly inputting the dimensional values of the paper size, the automated operation is supposed to be preferable for facilitating the print output, because the user can intuitively perform the operation.

### SUMMARY OF THE INVENTION

An object of the invention is to provide a print information processing apparatus, a print information processing method and a print information processing program in which the paper size can be automatically set up and localization is allowed.

In order to accomplish the above object, according to the present invention, there is provided a print information processing apparatus for printing the image data, and having an application for setting the paper size of the paper on which the image data is printed, comprising:

a storage part for storing the paper information defining the paper size and a first identifier corresponding to the paper information;

an input part for inputting a second identifier corresponding to the paper information; and

an information setting part for reading the paper information associated with the first identifier matched with the second identifier from the storage part, based on the second identifier inputted by the input part, and outputting the paper size defined by the paper information.

With this constitution, the paper size for use in the print driver can be automatically set up only by inputting the second identifier, whereby any troublesome operations for the user, including directly inputting the dimensional values of the paper size in the print information process, are unnecessary, and the convenience for the user is improved.

Also, since the paper size defined by the paper information stored in the storage part can be used for printing by inputting the second identifier, the print information processing apparatus can be localized inexpensively and simply without preparing an individual application for each country or district.

The print information processing apparatus may further comprise a print driver, in which the information setting part outputs the paper size defined by the paper information to the print driver, and the paper size defined by the paper information is longitudinal and transversal dimensional values of the paper on which the image data is printed.

With this constitution, the paper size defined by the paper information associated with the first identifier is outputted to the print driver as the longitudinal and transversal dimensional values of the print paper for use in actual printing. Thereby, the paper size out of the category of the print paper of regular size (A3, A4 and so on) can be set for the print driver.

The print information processing apparatus may further comprise a template acquisition part containing a third identifier corresponding to the paper information and storing a template of making a predetermined processing on the image data in the storage part, and a paper information acquisition part for storing the paper information associated with the third identifier as the paper information associated with the first identifier in the storage part with the third identifier contained in the template as the first identifier.

With this constitution, if the template is acquired, the first identifier matched with the third identifier and the paper information associated with the first identifier are acquired, based on the third identifier contained in the template. Thereby, the first identifier and the paper information in the storage part can be acquired only by newly acquiring the template, whereby the print information processing apparatus can be simply localized.

The print information processing apparatus may further comprise a display control part for displaying the template containing the third identifier matched with the second identifier on a display screen, based on the second identifier inputted by the input part.

With this constitution, a template file alone containing the third identifier matched with the selected paper size can be displayed on the display screen, whereby the convenience for the user is improved.

The template acquisition part may acquire the template from an external storage medium.

With this constitution, the template can be simply acquired without retrofitting the application, whereby the localization of the print information processing apparatus can be further promoted.

The print driver may set up the paper size of the paper on which the image data is printed, based on the dimensional values of the paper size outputted from the information setting part.

With this constitution, the paper size can be automatically set up in the print driver easily in which it is unnecessary that the user directly inputs the dimensional values of the paper size into the user defined item in arbitrary settable area of the paper size in the print driver, where by the process for setting the paper size in the print information processing apparatus is simplified.

The print information processing apparatus may further comprise an identification information generation part for acquiring the print information of a printer managed by the print driver and generating the identification information of the paper size printable on the printer, based on the acquired print information and the paper information associated with the first identifier, and a display control part for displaying the selectable printer for printing on the display screen, using the identification information generated by the identification information generation part.

With this constitution, the paper size printable on the printer can be identified, and the selectable printer can be displayed on the display screen, thereby improving the user interface (UI).

According to the invention, there is also provided a print information processing method, comprising:.

inputting a second identifier corresponding to the paper information defining the paper size of the paper on which the image data is printed in printing the image data; and

outputting the paper size defined by the paper information corresponding to a first identifier matched with the second identifier to a print driver, based on the input second identifier.

With this constitution, the paper size for use in the print driver can be automatically set up only by inputting the second identifier, whereby any troublesome operations for the user, including directly inputting the dimensional values of the paper size in the print information process, are unnecessary, and the convenience for the user is improved. Also, since the paper size defined by the paper information associated with the first identifier matched with the second identifier can be used for printing by inputting the second identifier, the paper setting operation for the print driver in the print information process is unnecessary, and the processing is simplified.

According to the invention, there is also provided a print information processing program for enabling a computer to perform the print information processing method.

With this constitution, various effects obtained by implementing the above print information processing method can be achieved.

### BRIEF DESCRIPTION OF THE DRAWINGS

other objects, features and advantages of the present invention will be more readily apparent from the following detailed description of the preferred embodiments thereof, when considered in conjunction with the accompanying drawings.

FIG. 1 is a configuration view showing one example of a schematic configuration of a print system having a print information processing apparatus.

FIG. 2 is an explanatory diagram showing one example of a functional configuration of the print information processing apparatus.

FIG. 3 is an explanatory view showing one example of the organization substance of paper information and the identifier.

FIG. 4 is an explanatory view showing one example of the hardware configuration of the print information processing apparatus.

FIG. 5 is an explanatory view showing one example of the data organization substance of template.

FIG. 6 is a flowchart showing one example of a print information processing procedure of the print information processing apparatus.

FIG. 7 is a flowchart showing one example of the print information processing procedure of the print information processing apparatus.

FIG. 8 is an explanatory view showing one example of a top menu screen.

FIG. 9 is an explanatory view showing one example of a paper size selection screen.

FIG. 10 is an explanatory view showing one example of a template selection screen.

FIG. 11 is an explanatory view showing one example of a media selection screen.

FIG. 12 is an explanatory view showing one example of an image selection screen.

FIG. 13 is an explanatory view showing one example of a layout edit screen.

FIG. 14 is an explanatory view showing one example of a print screen.

FIG. 15 is a flowchart showing one example of a template display processing procedure.

FIG. 16 is a flowchart showing one example of a set-up processing procedure.

FIG. 17 is an explanatory view showing one example of a management screen.

FIG. 18 is an explanatory view showing one example of an environment setting screen.

FIG. 19 is an explanatory view showing one example of a detail setting screen.

FIG. 20 is a flowchart showing one example of a print processing procedure.

FIG. 21 is an explanatory view showing one example of a property setting screen.

FIG. 22 is an explanatory view showing another example of the detail setting screen.

### DETAILED DESCRIPTION OF THE EMBODIMENTS

Embodiments of a print information processing apparatus, a print information processing method and a print information processing program according to the present invention will be described below in detail with reference to the accompanying drawings.

(Schematic Configuration of Print System Having Print Information Processing Apparatus)

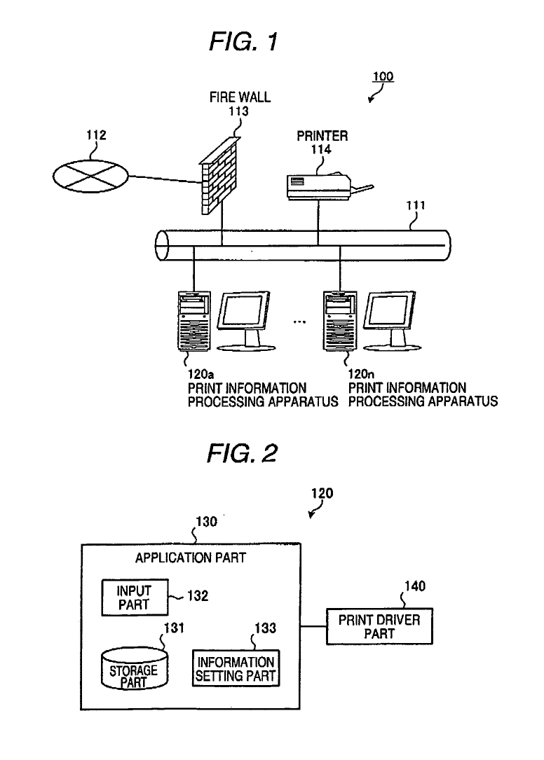

FIG. 1 is a configuration view showing one example of a schematic configuration of a print system having a print information processing apparatus according to this embodiment. As shown in FIG. 1, the print system 100 is installed at a shop such as a photo processing shop, and comprises a plurality of print information processing apparatuses 120a to 120n according to this embodiment. The plurality of print information processing apparatuses 120a to 120n are connected via a local network 111 to a printer 114 of laser or ink jet method. Also, the local network 111 is connected via a fire wall 113 to a global network 112. In the following, the plurality of print information processing apparatuses 120a to 120n have the same constitution, and are generically referred to as a print information processing apparatus 120, unless otherwise noted.

(Functional Configuration of Print Information Processing Apparatus)

FIG. 2 is an explanatory diagram showing one example of a functional configuration of the print information processing apparatus according to this embodiment. The print information processing apparatus 120 of this embodiment is composed of a typical personal computer in which a print information processing program, not shown, as an application and a print driver are installed, and performs the print information processing, when the print information processing program is executed.

As shown in FIG. 2, the print information processing apparatus 120 comprises an application part 130 for performing a plurality of printing services using a template to make a predetermined design processing on a pictorial image of any image data, and a print driver part 140 for controlling a printer 114 (see FIG. 1, ditto) via the local network 111 (see FIG. 1, ditto).

The application part 130 comprises a storage part 131, an input part 132 and an information setting part 133. The storage part 131 stores the information concerning the paper size (hereinafter referred to as “paper information”) that defines the paper size and a first identifier associated with the paper information, and functions as a database. Herein, first of all, the organization of the paper information and the identifier stored in the storage part 131 will be described below. The identifier stored in the storage part 131 is defined as a first identifier and the identifier inputted into the input part 132 is defined as a second identifier. However, the first and second identifiers are simply referred to as the identifier, unless otherwise noted.

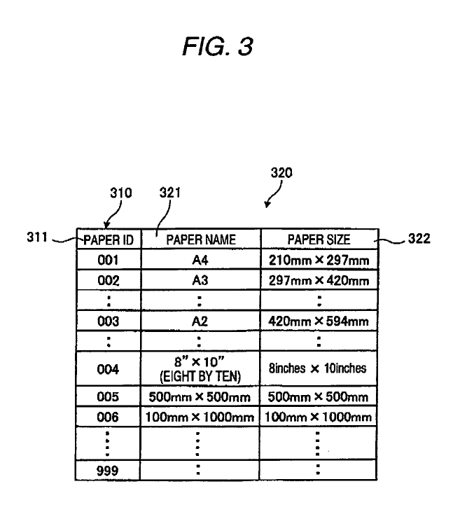

FIG. 3 is an explanatory view showing one example of the organization substance of paper information and the identifier stored in the storage part of the application part. As shown in FIG. 3, the paper information 320 stored in the storage part 131 (see FIG. 2, ditto) is composed of a paper name 321 and a paper size 322, for example, in which the identifier 310 is a paper ID 311. The paper information 320 and the identifier 310 are associated with each other and stored in the storage part 131.

The paper name 321 of the paper information 320 is the name of regular size such as “A3”, “A4” or “8”×10” (eight by ten), or the name of dimensional values such as “500 mm×500 mm”. The paper size 322 of the paper information 320 is composed of dimensional values such as “210 mm×297 mm” or “8 inch×10 inch”. On the other hand, the paper ID 311 of the identifier 310 is a numerical value ranging from “001” to “999”.

The paper information 320 and the identifier 310 organized in this way are associated with each other and stored in the storage part 131, as described above. For example, if the paper ID 311 of the identifier 310 is “001”, the paper name 321 of the paper information 320 is “A4” and the paper size 322 is “210 mm×297 mm”.

The input part 132 accepts an input of the identifier 310 as the second identifier defining the paper size 322. That is, the input part 132 inputs the paper ID 311 of the identifier 310 defining the paper size 322 of the paper information 320 into the application part 130 of the print information processing apparatus 120, as shown in FIG. 3.

The input of the identifier 310 by this input part 132 may be made by accepting the identifier 310 from template acquisition means as will be described later, the identifier 310 related to a template acquired by the template acquisition means, for example, in a case where the identifier 310 is related to the template with various printing services for making a predetermined design process on the pictorial image of any image data.

The information setting part 133 reads the paper information 320 associated with the identifier 310 as the first identifier matched with the identifier 310 as the second identifier out of the storage part 131, based on the identifier 310 as the second identifier inputted by the input part 132, and outputs the paper size 322 defined by the read paper information 320 to the print drive part 140. More specifically, this information setting part 133 outputs the longitudinal and transversal dimensional values of the print paper (not shown) for use in actually printing on the printer 114 (see FIG. 1, ditto) as the paper size 322 outputted to the print driver part 140, based on the paper information 320 read out of the storage part 131.

That is, in a case where the paper ID 311 of the input identifier 310 is “002”, for example, the information setting part 133 reads the paper information 320 in which the paper name 321 associated with the paper ID 311 is defined as “A3” and the paper size 322 as “297 mm×420 mm” out of the storage part 131, and outputs the dimensional values of the paper size 322 in the read paper information 320 to the print driver part 140.

In the application part 130 of this print information processing apparatus 120, the information setting part 133 can output the paper size 322 defined by the paper ID 311 of the identifier 310 to the print driver part 140. Therefore, in this print information processing apparatus 120, the paper size 322 can be automatically set in the application 130 without making the environmental settings concerning the printing for the print driver part 140 itself.

On the other hand, the print driver part 140 controls the driving of the printer 114 via the local network 111 and manages the information concerning the printing of the printer 114 (hereinafter referred to as “print information”). The print information includes the information concerning the type of paper (plain paper, special paper and so on), the information concerning the print output profile, and the price information concerning the print output, for example. This print driver part 140 manages the print information of each printer 114, if there are a plurality of printers 114 within the local network 111. Next, the hardware configuration of the print information processing apparatus 120 will be described below.

(Hardware Configuration of Print Information Processing Apparatus)

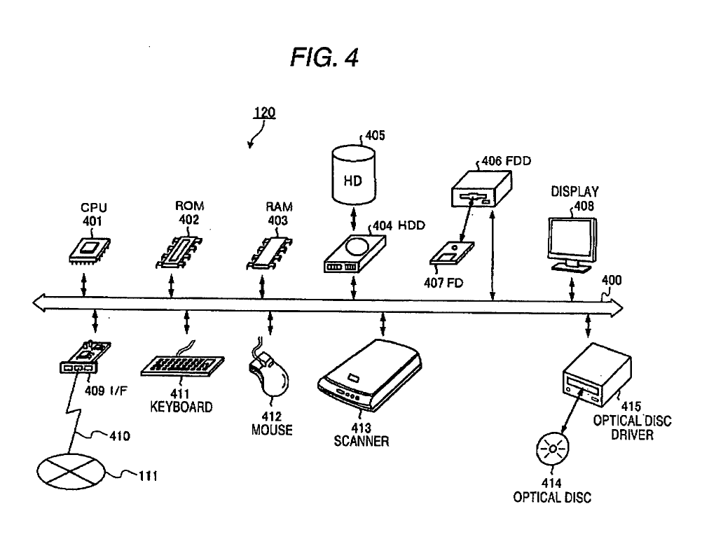

FIG. 4 is an explanatory view showing one example of the hardware configuration of the print information processing apparatus according to this embodiment. Herein, a print information process is performed using the identifier related to the template. In the following, the already described parts are designated by the same reference numerals, and not described again.

The print information processing apparatus 120 of this embodiment comprises a CPU 401, a ROM 402, a RAM 403, an HDD (hard disk drive) 404, an HD (hard disk) 405, an FDD (flexible disk drive) 406, an FD (flexible disk) 407, and a display 408.

Also, the print information processing apparatus 120 comprises an interface (I/F) 409, a keyboard 411, a mouse 412, a scanner 413, an optical disk 413, and an optical disk drive 415. The application part 130 (see FIG. 2, ditto) reads the paper information 320 (see FIG. 3, ditto) using the identifier 310 (see FIG. 3, ditto) related to the template and outputs the paper size 322 (see FIG. 3, ditto) defined by the read paper information 320 to the print driver part 140 (see FIG. 2, ditto) to set up the paper size 322. The above components 401 to 415 are interconnected via a bus 400.

The CPU (central Processing Unit) 401 performs the predetermined arithmetical operations, controls the overall print information processing apparatus 120, and implements the functions of the information setting part 133 (see FIG. 2, ditto). The ROM (Read Only Memory) 402 stores various control programs. Various control programs may be stored in a storage device (recording medium) such as the HD 405, besides the ROM 402. The data stored in the ROM 402 is rewritable by a user's operation, but not deleted by turning off the power.

The CPU 401 acquires the template related to the identifier 310 from the optical disk 414 via an optical disk drive 415, accepts an input of the identifier 310, reads the paper information 320 stored in the HD 405 based on this identifier 310, and outputs the paper size 322 defined by this paper information 320 to the print driver part 140, in accordance with the print information processing program of this embodiment.

Also, the CPU 401 acquires the identifier 310 as the first identifier matched with the identifier 310 and the paper information 320 associated with the identifier 310 via the I/F 409 from an external server (not shown), based on the identifier 310 as the second identifier related to the acquired template. And the CPU 401 associates the paper information 320 acquired from the external server with the identifier 310 related to the template, and controls the HDD 404 to write and update in the HD 405.

Further, the CPU 401 acquires the print information of the printer 114 (see FIG. 1, ditto) managed by the print driver part 140, and generates the identification information for identifying the paper size 322 that can be printed by the printer 114, based on the acquired print information and the paper information 320 associated with the identifier 310. Also, the CPU 401 displays the printer 114 that can be selected for printing on a display screen of the display 408, using the generated identification information of the paper size 322, and displays various kinds of information on the display 408.

In addition, the CPU 401 generates a print job for executing the print output by the printer 114 for a printing service selected from a plurality of printing services such as a great enlargement printing service and a poster print printing service, and controls the printer 114 to perform the print output, based on this print job.

In this way, the CPU 401 implements the functions of the input part 132 and the information setting part 133 in the application part 130, as well as the functions of the print driver part 140, as shown in FIG. 2. Also, the CPU 401 may update the identifier 310 and the paper information 320 stored in the HD 405, or implement the functions of identification information generation means for generating the identification information of the printable paper size 322 and display control means for displaying various kinds of information on the display 408, as described above.

The RAM (Random Access Memory) 403 stores the variable data rewritably and functions as a work area of the CPU 401. This RAM 403 may be a volatile memory in which the stored data is deleted by turning off the power, or a non-volatile memory backed up by a battery. The RAM 403 may store temporarily or permanently various kinds of information such as template or paper information 320.

The HDD 404 controls the read/write of information from or into the HD 405 in accordance with a control instruction of the CPU 401. The print information processing program is recorded in an MO (Magneto-Optical disk) or a memory card, a dedicated drive device at least capable of reading the recorded information may be employed, instead of the HDD 404, or together with the HDD 404.

The HD 405 records various control programs or various kinds of information to be readable by the CPU 401. The HD 405 accepts the information to be written by the HDD 404 and records the written information in non-volatile manner. This HD 405 records various kinds of information required for performing the print information processing program, together with the print information processing program. Accordingly, the storage part 131 of the application part 130 as shown in FIG. 2 implements the functions using the HD 405.

The print information processing program is not necessarily recorded on the HD 405. Instead of the HD 405, the print information processing program may be recorded on the MO, memory card, or optical disk (DVD, CD, CD-ROM (CD-R, CD-RW)) 414. For example, when the print information processing program recorded on the optical disk 414 is employed, the print information processing program is read into the CPU 401 by the optical disk drive 415 at least capable of reading the information recorded on the optical disk 414 in this print information processing apparatus 120.

Also, the HD 405 may store the print driver part 140 for managing the print information or controlling the driving of the printer 114, for example. This print driver part 140 performs a process for operating the printer 114 via the local network 111, and plays a role of bridging a gap between the print information processing apparatus 120 and the printer 114. Besides, the print driver part 140 may be comprised of a firmware, or an ASIC (Application Specific Integrated Circuit).

The FDD 406 controls the read/write of information from or into the FD 407 in accordance with a control instruction of the CPU 401. The FD 407 is a removable recording medium that accepts the information written by the FDD 406, and records the written information in non-volatile manner.

The display 408 is composed of a display unit, such as a CRT (Cathode Ray Tube), a TFT (Thin Film Transistor) liquid crystal display, an organic EL (Eelectroluminescence) display, or a plasma display. More specifically, this display 408 may be composed of a display unit for video display connected to a video I/F, not shown.

On the display 408, an icon, a cursor, a menu, a window, and various kinds of information such as character or image are displayed. More specifically, a selection screen for a printing service performed by the print information processing apparatus 120 or environment setting for various functions involving this printing service is displayed on the display 408.

The I/F 409 is composed of a network board connected via a communication cable 410 to the local network 111, and functioning as the interface between the local network 111 and the CPU 401. And the I/F 409 serves to transmit or receive various kinds of information to or from another print information processing apparatus 120 or another equipment via the local network 111. Besides, this I/F 409 may be composed of a slot part for memory card or a communication module for making the radio communication.

Herein, the transmission or reception of various kinds of information through the I/F 409 may or may not be wired. More specifically, the print information processing apparatus 120 of this embodiment receives the paper information 320 transmitted from an external server on a global network 112 (see FIG. 1, ditto) connected via the local network 111 and transmits the received paper information 320 to the CPU 401 in accordance with a control instruction of the CPU 401. Accordingly, the I/F 409 implements the functions of the paper information acquisition means for acquiring the paper information 320. The paper information 320, which is recorded on the optical disk 414, may be acquired from the optical disk drive 415 into the print information processing apparatus 120.

Herein, if the I/F 409 is composed of a communication module for making the radio communication, no wire such as communication cable 410 of communication medium is necessary, and various kinds of information may be transmitted or received using the electric wave, infrared ray or ultrasonic wave. There are various standards enabling this radio communication, including radio LAN (Local Area Network), IrDA (Infrared Data Association), HomeRF (Home Radio Frequency), and BlueTooth. In this embodiment, various well-known radio communication techniques may be employed.

The keyboard 411 has a plurality of keys for inputting the characters, numerical values and various instructions, in which the information inputted by the user (hereinafter “input information”) is outputted to the CPU 401. The mouse 412 is a device for making the selection or execution of various instructions, selection of a processing object, or movement of the cursor, in which the input information by the user is outputted to the CPU 401, like the keyboard 411.

To output the input information by the user to the CPU 401, like the keyboard 411 and the mouse 412, a push button switch for detecting whether the button is physically depressed, a touch panel, a joy stick, and a track ball may be employed in various well-known forms. Also, a microphone for inputting the voice from the outside may be used to output the input information through the voice recognition to the CPU 401.

Herein, when the touch panel is employed to output the input information by the user to the CPU 401, the touch panel may be laminated on the display screen of the display 408. In this case, the input information can be recognized by managing the display timing of various kinds of information on the display 408, the operation timing on the touch panel, and its position coordinates. In this way, if the touch panel is employed, the print information processing apparatus 120 can be reduced in size, and the amount of information input operations increased. Various types of touch panel such as resistive film type or pressure sensitive type may be employed.

The scanner 413 is a device that optically reads the character, graphics, or image from the paper and inputs the image data, and composed of a flat head scanner or a handy scanner having a sensor such as CCD (Charge Coupled Device) or a CMOS (Complementary Metal Oxide Semiconductor).

The optical disk 414 is a recording medium with portability and removably mounted on the optical disk drive 415. For example, the optical disk records a plurality of templates for use in the printing services and the identifier 310 related to these templates. Also, the optical disk 414 records various kinds of information such as image data of photograph or the print information processing program.

The optical disk drive 415 reads or writes the information from or into the optical disk 414 in accordance with a control instruction of the CPU 401. Accordingly, when the template and the identifier 310 are recorded on the optical disk 414, the optical disk drive 415 implements a function of template acquisition means for acquiring the template. The template may be acquired via the I/F 409 from the external server into the print information processing apparatus 120.

Herein, when the optical disk 414 is a CD-ROM (CD-R, CD-RW), the optical disk drive 415 is implemented by a CD-ROM drive. The CD-ROM drive is the well known technique, and not illustrated and described here. Also, when the recording medium replacing the optical disk 414 is employed, the optical disk drive 415 may be composed of a drive device at least capable of reading the recording medium for use. Next, a data organization of the template recorded on the optical disk 414 will be described below.

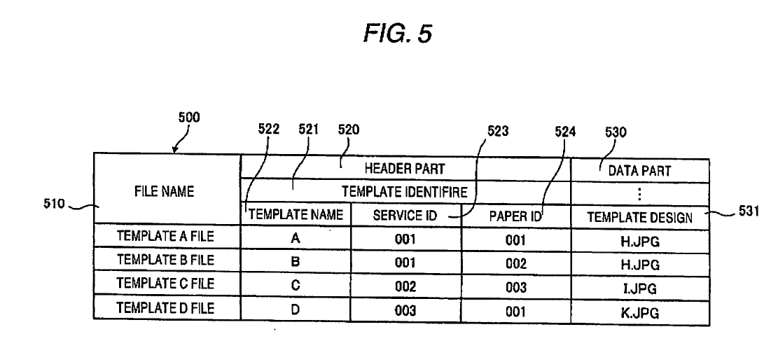

FIG. 5 is an explanatory view showing one example of the data organization substance of the template recording on the optical disk. As shown in FIG. 5, the template 500 has a file name 510, a header part 520 and a data part 530. The file name 510 indicates the file name of the template 500, for example, “template A file”.

The header part 520 includes a template identifier 521 as one element group, in addition to a data size and a data start address of the template 500, and the header information such as thumbnail of data. The template identifier 521 has a template name 522, a service ID 523 and a paper ID 524.

The template name 522 of the template identifier 521 indicates the name of the template 500, such as “A” or “B”, for example. The service ID 523 of the template identifier 521 indicates a printing service that uses the template, and is composed of a numerical value from “001” to “999”, for example. The paper ID 524 of the template identifier 521 is the same as the paper ID 311 (see FIG. 3, ditto) of the identifier 310, and related one-to-one with the template 500.

The data part 530 has a template design 531 as one element group, in addition to various kinds of information (data) concerning the template 500. The template design 531 of the data part 530 indicates a layout design used for the template, and is composed of JPEG image such as “H.JPG” or “I.JPG” and other layout images.

In the template 500, the paper ID 524 different for each paper size 322 (see FIG. 3, ditto) is given to the same template design 531, or conversely, the same paper ID 524 is given to different template design 531 to make up the data. Therefore, when the user selects one paper size 322, the template 500 adaptable to the paper size 322 selected from among a plurality of templates 500 is extracted, so that the desired template 500 can be selected.

Next, as one example of the print information processing that is performed by the print information processing apparatus 120, a process for acquiring the template 500 and the identifier 310 recorded on the optical disk 414, and registering the paper size 322 in the application part 130 using the paper information 320 stored in the HD 405 will be described below.

(Print information processing procedure of print information processing apparatus)

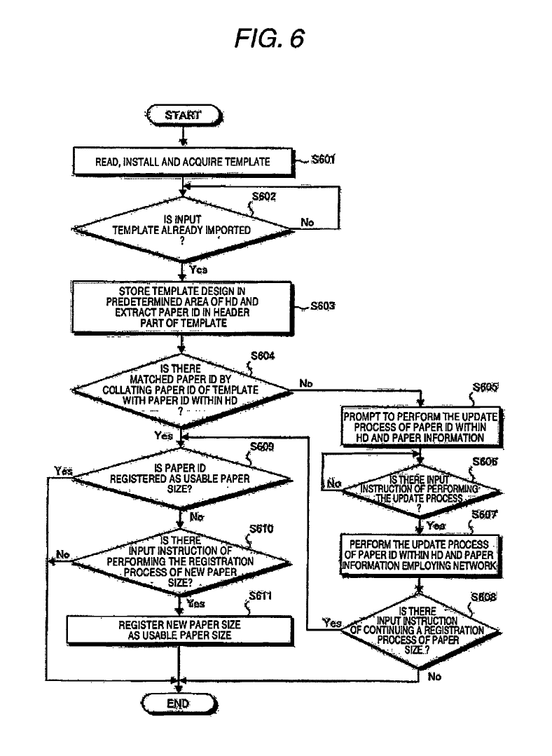

FIG. 6 is a flowchart showing one example of the print information processing procedure in the print information processing apparatus according to this embodiment. Referring to FIG. 6, the print information processing procedure of this embodiment will be described below. In the following, the explanation is made chiefly using FIG. 4, in which the already described parts are designated by the same reference numerals, and not described again.

Specifically, the process of FIG. 6 is performed by the application part 130 as shown in FIG. 2, in which the print information processing program stored (recorded) in the ROM 402, the RAN 403, the HD 405 or the optical disk 414 for the print information processing apparatus 120 as shown in FIG. 4 is executed by the CPU 401 to acquire the template 500 of FIG. 5 as the information recorded in the optical disk 414.

In the print information processing procedure, first of all, the template 500 is read from the optical disk 414 inserted into the optical disk drive 415 by the user, installed and acquired (step S601). Then, the CPU 401 judges whether or not the template 500 inputted into the application part 130 is already imported, based on the template identifier 521 of the acquired template 500 (step S602).

If it is judged that the input template 500 is not already imported (step S602): No), the processing is repeated. If it is judged that the input template 500 is already imported (step S602: Yes), the CPU 401 stores the template design 531 of the template 500 in a predetermined area of the HD 405, and extracts the paper ID 524 from the header part 520 of the template 500 (step S603). This process for extracting the paper ID 524 at step S603 may be performed based on the input information from the user that is inputted using the keyboard 411 or the mouse 412, for example.

If the paper ID 524 is extracted at step S603, the CPU 401 reads the paper information 320 associated with the extracted paper ID 524 from the HD 405, and determines whether or not the paper IDs 311 are matched by collating the paper ID 524 of the template 500 with the paper ID 311 in the HD 405 (step S604).

If it is determined that the paper IDs 311 are unmatched (step S604: No), the CPU 401 prompts the user to perform an update process for the paper ID 311 and the paper information 320 in the HD 405 on the display screen of the display 408 (step S605). And the CPU 401 judges whether or not there is an input instruction of performing the update process from the user, based on the input information from the keyboard 411 or the mouse 412 (step S606).

If it is judged that there is no input instruction of performing the update process (step S606: No), the processing is repeated till the input instruction is made. If it is judged that the input instruction of performing the update process is made (step S606: Yes), the CPU 401 acquires the paper ID 311 and the paper information 320 from an external server (not shown) via the I/F 409, the local network 111 and the global network 112, and performs the update process for the paper ID 311 and the paper information 320 in the HD 405 using the network (step S607).

And the CPU 401 judges whether or not there is an input instruction of continuing to perform a registration process for the paper size 322 to the application part 130 by the user, based on the input information from the keyboard 411 or the mouse 412 (step S608). If it is judged that there is no input instruction of continuing to perform the registration process (step S608: No), the print information process is ended.

If it is judged that there is any input instruction of continuing to perform the registration process (step S608: Yes) and if it is judged at step S604 that the paper ID 311 are matched (step S604: Yes), the CPU 401 judges whether or not the paper ID 311 is registered as the usable paper size 322 in the application part 130, using the print information of the printer 114 managed by the print driver part 140 (step S609).

If it is judged that the paper ID 311 is registered as the usable paper size 322 (step S609: Yes), the print information process is ended. If it is judged that the paper ID 311 is not registered as the usable paper size 322 (step S609: No), the CPU 401 judges whether or not there is an input instruction of performing the registration process for the new paper size 322 by the user, based on the input information from the keyboard 411 or the mouse 412 (step S610). At step S610, a message of selecting whether or not to perform the registration process for the new paper size 322 may be made on the display screen of the display 408, for example.

And if it is judged that there is no input instruction of performing the registration process (step S610: No), the print information process is ended. If it is judged that there is any input instruction of performing the registration process (step S610: Yes), the CPU registers the new paper size 322 as the usable paper size in the application part 130 (step S611). Thereby, the print information process in accordance with this flowchart is ended. If the paper size is registered in this way, the already registered paper size can be directly used, and the unregistered paper size can be registered by the print driver part 140, whereby there is less burden on the processing of defining the width and length of the paper on the side of the application part 130.

Next, as one example of the print information process performed by the print information processing apparatus 120, a process of creating a print job using the template 500 on the application part 130 will be described below to perform a printing service selected from among a plurality of printing services when the registration process for the paper size 322 is performed as described above.

(Print Information Processing Procedure of Print Information Processing Apparatus)

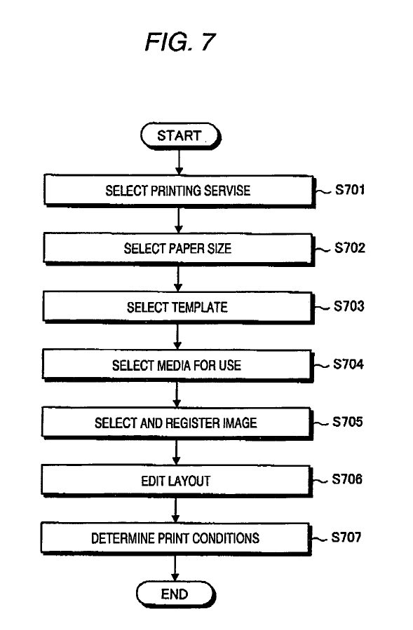

FIG. 7 is a flowchart showing one example of the print information processing procedure in the print information processing apparatus according to this embodiment. Referring to FIG. 7, the print information processing procedure of this embodiment will be described below. Specifically, the process of FIG. 7 is performed by the application part 130 as shown in FIG. 2, in which the print information processing program stored (recorded) in the ROM 402, the RAM 403, the HD 405 or the optical disk 414 for the print information processing apparatus 120 as shown in FIG. 4 is executed by the CPU 401. Herein, the print information processing apparatus 120 has a constitution in which a touch panel is laminated on the display screen of the display 408 (see FIG. 4, ditto). Also, the paper size 322 and the template 500 are generally referred to as the paper size and the template.

In the print information processing procedure, first of all, the CPU 401 displays a top menu screen on the display screen of the display 408, and selects a desired printing service from among a plurality of printing services displayed on the top menu screen, based on the input information from the touch panel by the user (step S701). Herein, the top menu screen for selecting the printing service will be described below.

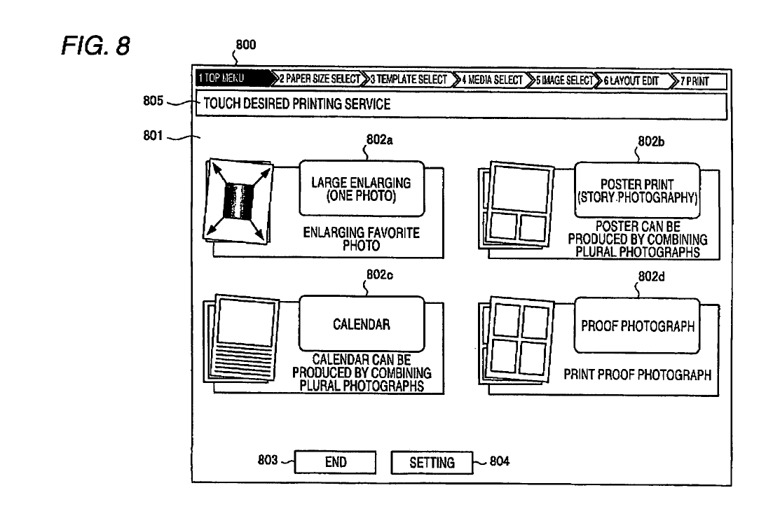

FIG. 8 is an explanatory view showing one example of a top menu screen for selecting the printing service. The top menu screen 800 displayed on the display screen of the display 408 as shown in FIG. 4 is provided with a service selection area 801 for selecting the printing service. In this service selection area 801, there are provided a plurality of input buttons 802a to 802d that are contacted by the input operation of the user to select the desired printing service.

Of the plurality of input buttons 802a to 802d, an input button 802a is provided to select an “enlargement” printing service of enlarging and printing the image such as photograph, and an input button 802b is provided to select a “poster print” printing service of printing a combination of plural images such as photographs as the poster. Also, an input button 802c is provided to select a “calendar” printing service of printing a combination of plural images such as photographs as the calendar, and an input button 802d is provided to select a “certificate photograph” printing service of printing the image such as photograph as the certificate photograph.

In the service selection area 801 on the top menu screen 800, an “end” button 803 for ending the printing service selection process and a “set-up” button 804 for transiting to a set-up screen for making various settings corresponding to each printing service are additionally provided. Also, in the service selection area 801, a message display area 805 for displaying a message of “Touch a desired printing service.” is provided.

If the user selects a desired printing service in the service selection area 801 on the top menu screen 800, the CPU 401 displays a paper size selection screen on the display screen of the display 408, and selects the desired paper size from among a plurality of paper sizes presented on the paper size selection screen, based on the input information from the touch panel by the user (step S702). Next, the paper size selection screen for selecting the paper size will be described below.

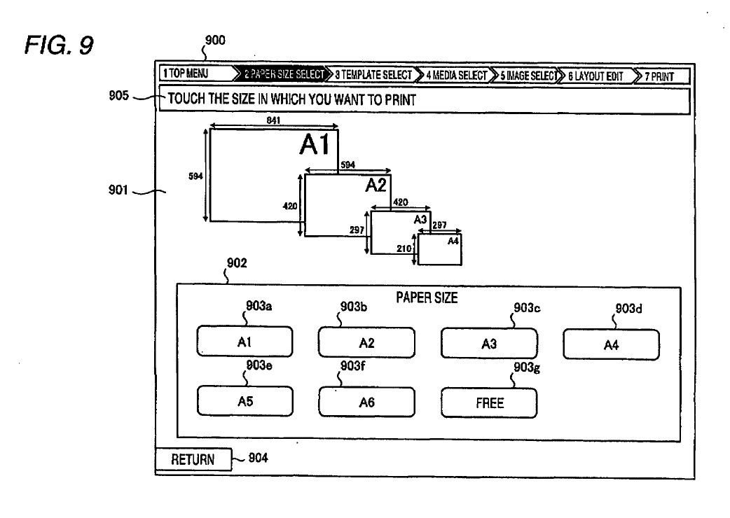

FIG. 9 is an explanatory view showing one example of a paper size selection screen for selecting the paper size. The paper size selection screen 900 is provided with a paper size display area 901 for displaying the print paper size in terms of the dimensional values and the image picture, and a paper size selection area 902 for selecting the paper size.

In this paper size selection area 902, there are provided a plurality of input buttons 903a to 903g that are contacted by the input operation of the user to select the desired paper size. In this paper size selection area 902, the selectable paper size in the selected printing service is displayed by using the identification information of the paper size printable on the printer 114 (see FIG. 1, ditto) registered in the paper size registration process, and further generated based on the print information from the print driver part 140 (see FIG. 2, ditto) and the paper information 320 associated with the paper ID 311 by the CPU 401.

Of a plurality of input buttons 903a to 903g, an input button 903a is provided to select the paper size of “A1”, and an input button 903b is provided to select the paper size of “A2”. Similarly, the input buttons 903c to 903f are provided to select the paper size of “A3”, “A4”, “A5” and “A6”, respectively. On the other hand, an input button 903g is provided to select the paper size of “free”. This “free” paper size can be set according to the definition by the user.

In the paper size display area 901 on the paper size selection screen 900, a “return” button 904 for returning to the top menu screen 900 is additionally provided. Also, in the paper size display area 901, a message display area 905 for displaying a message of “Touch a desired print size.” is provided.

If the user selects a desired print size in the paper size selection area 902 on the paper size selection screen 900, the CPU 401 displays a template selection screen on the display screen of the display 408, and selects the desired template from among a plurality of templates presented on the template selection screen, based on the input information from the touch panel by the user (step S703). Next, the template selection screen for selecting the template will be described below.

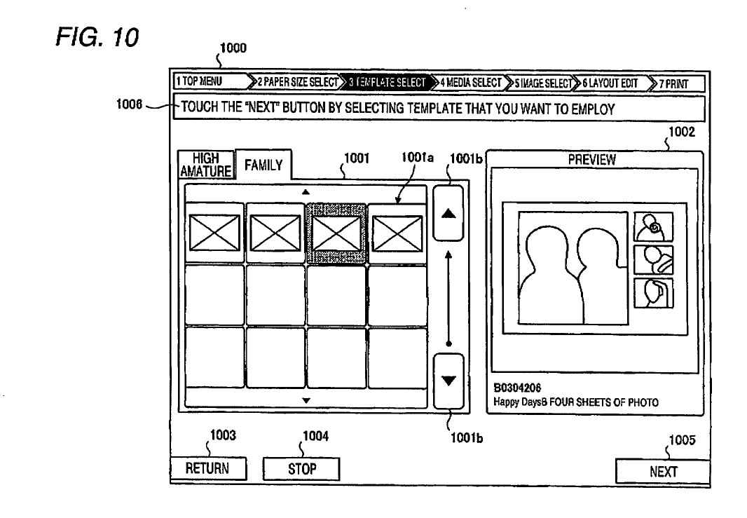

FIG. 10 is an explanatory view showing one example of a template selection screen for selecting the template. The template selection screen 1000 is provided with a template selection area 1001 for selecting the template and a preview display area 1002 for displaying a preview screen for a design process with the selected template.

In this template selection area 1001, there are provided a plurality of input buttons 1001a that are contacted by the input operation of the user to select the desired template and a plurality of movement buttons 1001b for moving the template displayed on the template selection area 1001. The template selection screen 1000 is further provided with a “return” button 1003 for returning to the paper size selection screen 900, a “stop” button 1004 for stopping the template selection process, and a “next” button 1005 for transiting to a media selection screen. Also, on the template selection screen 1000, a message display area 1006 for displaying a message of “Select a template you want to use and touch the “next” button.” is provided.

If the user selects a desired template in the template selection area 1001 on the template selection screen 1000 and performs an input operation for the “next” button 1005, the CPU 401 displays a media (recording media) selection screen on the display screen of the display 408, and selects the media for use from among a plurality of media presented on the media selection screen, based on the input information from the touch panel by the user (step S704). Next, the media selection screen for selecting the media will be described below.

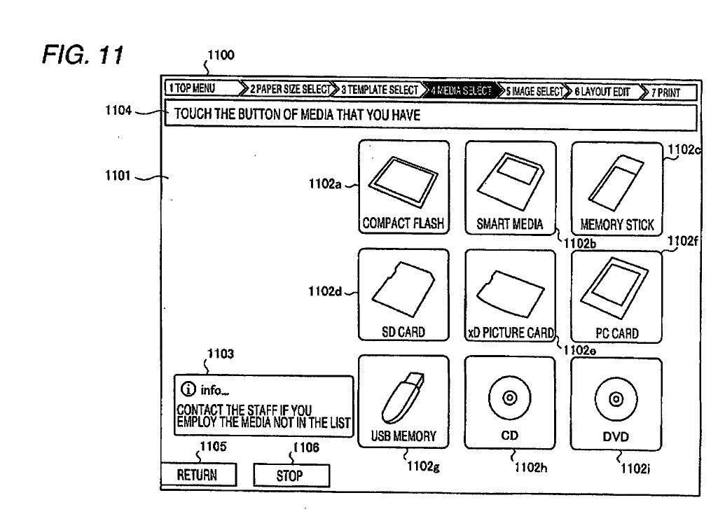

FIG. 11 is an explanatory view showing one example of the media selection screen for selecting the media. The media selection screen 1100 is provided with a media selection area 1101 for selecting the media for use. In this media selection area 1101, there are provided a plurality of input buttons 1102a to 1102i that are contacted by the input operation of the user to select the media for use.

Of a plurality of input buttons 1102a to 1102i, an input button 1102a is provided to select the “compact flash (registered trademark)”, and an input button 1102b is provided to select the “smart media (registered trademark)”. Also, an input button 1102c is provided to select the “memory stick (registered trademark)”, and an input button 1102d is provided to select the “SD card (registered trademark)”.

Similarly, an input button 1102e is provided to select the “xD picture card (registered trademark)”, and an input button 1102f is provided to select the “PC card”. Also, an input button 1102g is provided to select the “USB Memory”, an input button 1102h is provided to select the “CD”, and an input button 1102i is provided to select the “DVD”.

In addition to the media selection area 1101 on the media selection screen 1100, there are further provided a warning message display area 1103 for displaying a warning message of “Contact the clerk if you use the media not in the list.”, a message display area 1104 for displaying a message of “Touch the button for the media you have.”, a “return” button 1105 for returning to the template selection screen 1000, and a “stop” button 1106 for stopping the media selection process.

If the user selects the media for use in the media selection area 1101 on the media selection screen 1100, the CPU 401 retrieves and reads the image data recorded in the selected media, displays an image selection screen on the display screen of the display 408, and selects and registers the desired image from among a plurality of images presented on the image selection screen, based on the input information from the touch panel by the user (step S705). Next, the image selection screen for selecting and registering the image will be described below.

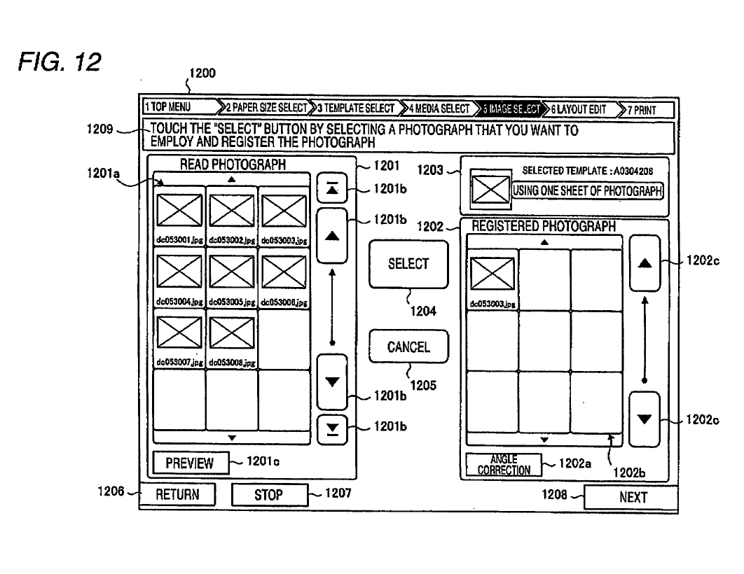

FIG. 12 is an explanatory view showing one example of the image selection screen for selecting and registering the image. The image selection screen 1200 is provided with an image selection area 1201 for selecting the read image, an image display area 1202 for displaying the selected and registered image, and a template display area 1203 for displaying the template selected on the template selection screen 1000.

In this image selection area 1201, there are provided a group of input buttons 1102a contacted by the input operation of the user to select the desired image, and a plurality of movement buttons 1201b for moving the displayed image on the image selection area 1201. Also, the image selection area 1201 is provided with a “preview” button 1201c for making the preview display of the selected image.

In the image display area 1202, there are provided an “angle correction” button 1202a for correcting the angle of the selected and registered image, a group of input buttons 1202b contacted by the input operation of the user to enable reselection of the registered image for angle correction, and a plurality of movement buttons 1202c for moving the displayed image on the image display area 1202.

On the image selection screen 1200, there are further provided a “selection” button 1204 for registering the selected image by contacting the group of input buttons 1201a in the image selection area 1201, and a “cancel” button 1205 for canceling the selected image by contacting the group of input buttons 1201b in the image display area 1202.

Also, on the image selection screen 1200, there are a “return” button 1206 for returning to the media selection screen 1100, a “stop” button 1207 for stopping the image selection process, and a “next” button 1208 for transiting to a layout edit screen. Moreover, on the image selection screen 1200, there is provided a message display area 1209 for displaying a message of “Select a photograph you want to use, touch the “selection” button, and register the photograph.” If registration is ended, touch the “next” button.”

If the user selects the desired image in the image selection area 1201 on the image selection screen 1200, and registers the image by the input operation on the “selection” button 1204, the CPU 401 makes a synthesis process for synthesizing the registered image with the selected template, displays a layout edit screen on the display screen of the display 408, and edits the layout of the image on the template, based on the input information from the touch panel by the user (step S706). Next, the layout edit screen for editing the layout will be described below.

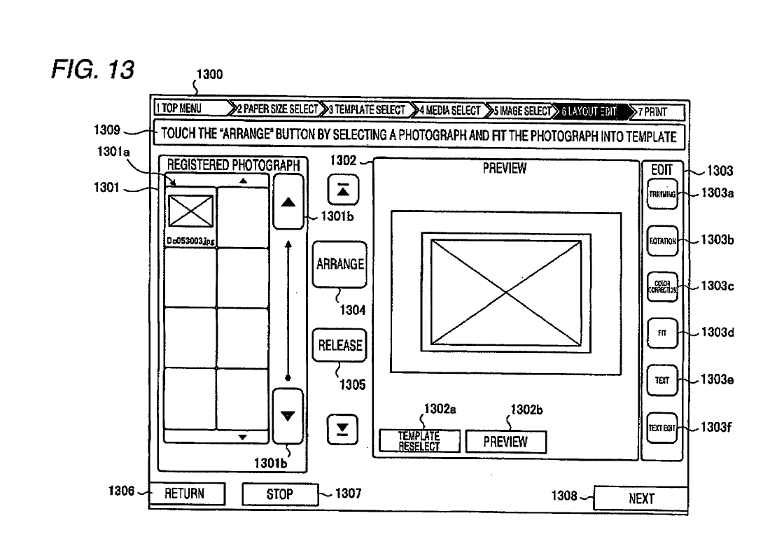

FIG. 13 is an explanatory view showing one example of the layout edit screen for editing the layout. The layout edit screen 1300 is provided with an image selection area 1301 for selecting the registered image, a preview display area 1302 for displaying a preview screen in performing a layout edit process by arranging the selected image on the template, and an edit button display area 1303 for displaying the selectable processing items in the layout edit process.

In this image selection area 1301, there are provided a group of input buttons 1301a contacted by the input operation of the user to select the registered image, and a plurality of movement buttons 1301b for moving the displayed image on the image selection area 1301. Also, the preview display area 1302 is provided with a “template reselection” button 1302a for reselecting the template and a “preview” button 1302b for making a preview display of the image after the layout edit process.

In the edit button display area 1303, there are provided a “trimming” button 1303a for trimming the image, a “rotation” button 1303b for rotating the image, a “color correction” button 1303c for making color correction of the image, a “Fit” button 1303d for fitting the image, a “text” button 1303e for adding a text to the image, and a “text edit” button 1303f for editing the added text.

On the layout edit screen 1300, there are further provided an “arrangement” button 1304 for arranging the image selected by contacting the group of input buttons 1301a in the image selection area 1301 on the template, and a “release” button 1305 for releasing the arrangement of the selected image on the template.

Also, on the layout edit screen 1300, there are a “return” button 1306 for returning to the image selection screen 1200, a “stop” button 1307 for stopping the layout edit process, and a “next” button 1308 for transiting to a print screen as will be described later. Moreover, on the layout edit screen 1300, there is provided a message display area 1309 for displaying a message of “Select a photograph, touch the “arrangement” button, and fit the photograph into the template.”

If the user makes a desired layout edit on the layout edit screen 1300, and performs the input operation on the “next” button 1308, the CPU 401 displays a print screen on the display screen of the display 408, and creates a print job including the information such as the set number of prints to actually print on the printer 114 (see FIG. 1, ditto), as well as determines the print condition (step S707). Thereby, the print information process according to this flowchart is ended. Next, the print screen for determining the print condition will be described below.

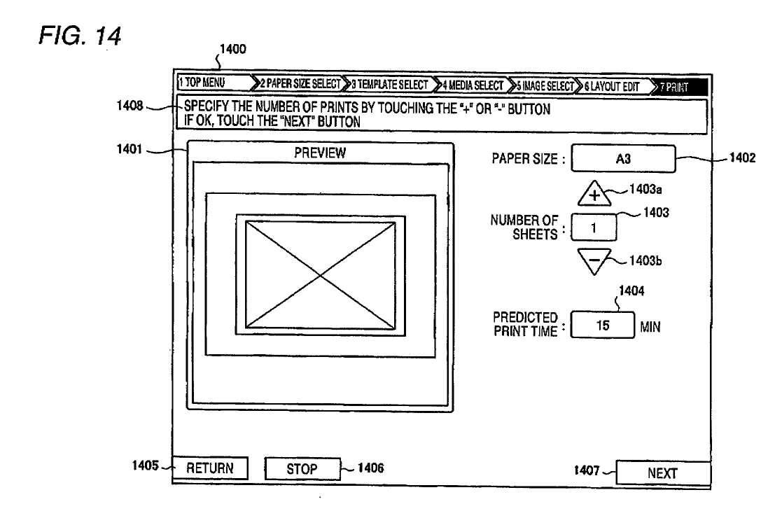

FIG. 14 is an explanatory view showing one example of the print screen for determining the print condition. The print screen 1400 is provided with a preview display area 1401 for displaying a preview screen of the actually printed image, a paper size display area 1402 for displaying the print paper size, a number of prints display area 1403 for displaying the number of prints, and a time display area 1404 for displaying the expected time taken for printing. The numerical value displayed in the number of prints display area 1403 can be changed using the number change buttons 1403a and 1403b.

Also, on the print screen 1400, there are a “return” button 1405 for returning to the layout edit screen 1300, a “stop” button 1406 for stopping a determination process for the print condition, and a “next” button 1407 for executing the printing. Moreover, on the print screen 1400, there is provided a message display area 1408 for displaying a message of “Specify the number of prints by touching the “+” and “−” buttons. If OK, touch the “next” button.”

In this way, in the print information process, when the print information processing program is executed, the printable paper size for printing can be automatically set up only through the processing performed in the application part 130 without separately performing the setting process to the print driver part 140. Thereby, the user is relieved of the troublesome work, and the convenience is improved.

Next, a template display process for displaying the template in the template selection area 1001 of the template selection screen 100 in the template selection process at step S703 will be described below.

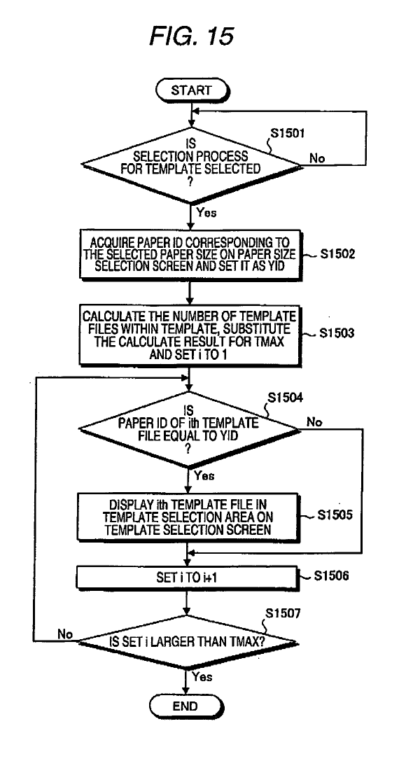

FIG. 15 is a flowchart showing one example of a display processing procedure in the template selection process at step S703. Specifically, the process as shown in FIG. 15 is performed by the application part 130 as shown in FIG. 2, and implemented by the CPU 401 executing the print information processing program stored (recorded) in the ROM 402, RAM 403, HD 405 or optical disk 414 of the print information processing apparatus 120 as shown in FIG. 4.

First of all, the user selects a desired paper size in the paper size selection area 902 on the paper size selection screen 900, and transiting to the template selection screen 1000, the CPU 401 judges whether or not the template selection process is selected (step S1501). If it is judged that the template selection process is not selected (step S1501: No), the process is repeated.

If it is judged that the template selection process is selected (step S1501: Yes), the CPU 401 reads the paper ID 311 and the paper information 320 from the HD 405, acquires the paper ID 311 corresponding to the paper size selected on the paper size selection screen 900, and sets it as YID (step S1502).

Next, the CPU 410 calculates the number of template files within the template 500, substitutes the calculation result for TMAX, and set i to 1 (step S1503). And the CPU 401 determines whether or not the paper ID 311 of the i-th template file is identical to YID (step S1504).

If it is determined that the paper ID 311 is identical to YID (step S1504: Yes), the CPU 401 displays the i-th template file in the template selection area 1001 on the template selection screen 1000 (step S1505), and sets i to i+1 (step S1506). If it is determined at step S1504 that the paper ID 311 is not identical to YID (step S1504: No), the CPU transits to step S1506.

And the CPU 401 determines whether or not the set i is greater than TMAX (step S1507). If it is determined that the set i is not greater than TMAX (step S1507: No), the CPU transits to step S1504 to repeat the process. On the other hand, if it is determined that the set i is greater than TMAX (step S1507: Yes), the display process according to this flowchart is ended.

In this way, in the template display process, only the template file having the paper ID 311 matched with the paper size selected on the paper size selection screen 900 can be displayed on the template selection screen 1000. Thereby, the convenience is improved. In the template display process, though the illustration and the detailed explanation are omitted, only the template file having the service ID 523 matched with the printing service selected on the top menu screen 800 may be displayed on the template selection screen 1000.

Next, a set-up process where an input operation is made on the “set-up” button 804 on the top menu screen 800 for the printing service selection process at step S701 will be described below.

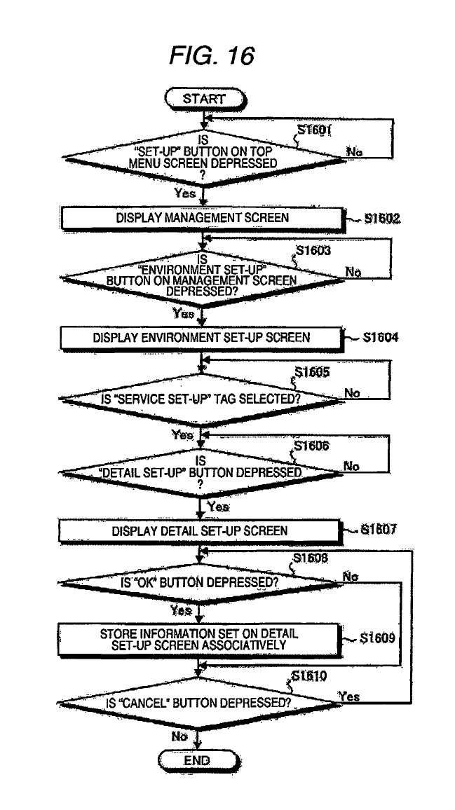

FIG. 16 is a flowchart showing one example of a set-up processing procedure in the printing service selection process at step S701. Specifically, the process as shown in FIG. 16 is performed by the application part 130 as shown in FIG. 2, and implemented by the CPU 401 executing the print information processing program stored (recorded) in the ROM 402, RAM 403, HD 405 or optical disk 414 of the print information processing apparatus 120 as shown in FIG. 4.

First of all, the CPU 401 judges whether or not the “set-up” button 804 on the top menu screen 800 is depressed by the input operation of the user (step S1601). If it is judged that the “set-up” button 804 is not depressed (step S1601: No), the process is repeated. If it is judged that the “set-up” button 804 is depressed (step S1601: Yes), the CPU 401 displays a management screen on the display screen of the display 408 (step S1602). Next, the management screen for making the set-up process will be described below.

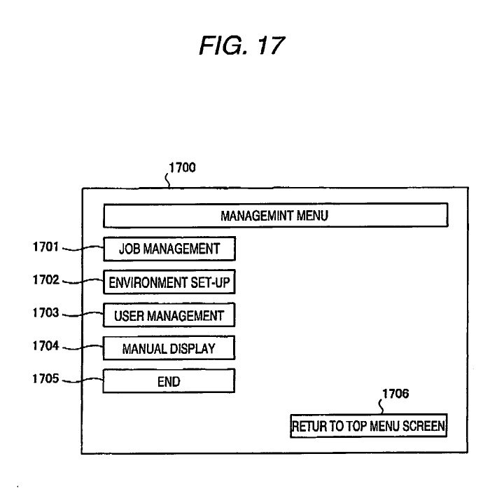

FIG. 17 is an explanatory view showing one example of the management screen for making the set-up process. The management screen 1700 is provided with a “job management” button 1701 for transiting to a job management screen for managing the print job, an “environment set-up” button 1702 for transiting to an environment set-up screen for making the environment set-up, a “user management” button 1703 for transiting to a user management screen for making the user management, a “manual display” button 1704 for displaying the manuals, an “end” button 1705 for ending the set-up process, and a “return to top menu screen” button 1706 for returning to top menu screen 800.

Then, the CPU 401 judges whether or not the “environment set-up” button 1702 on the displayed management screen 1700 is depressed by the input operation of the user (step S1603). If it is judged that the “environment set-up” button 1702 is not depressed (step S1603: No), the process is repeated. If it is judged that the “environment set-up” button 1702 is depressed (step 51603: Yes), the CPU 401 displays an environment set-up screen on the display screen of the display 408 (step S1604). Next, the environment set-up screen for making the set-up process will be described below.

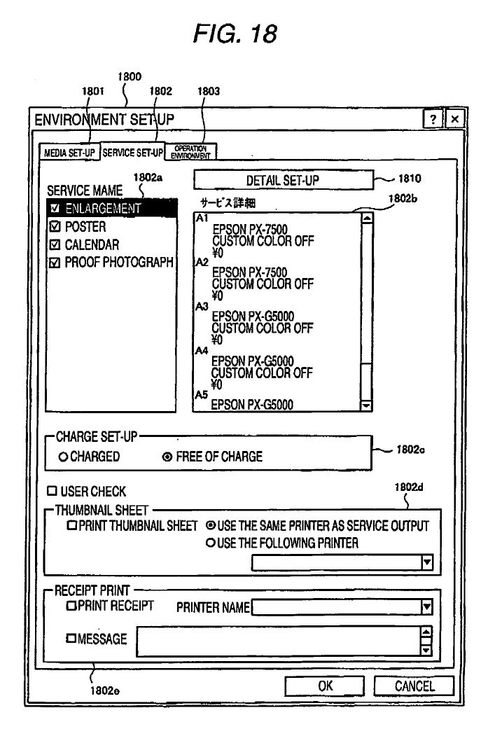

FIG. 18 is an explanatory view showing one example of the environment set-up screen for making the set-up process. The environment set-up screen 1800 is provided with a “media set-up” tab 1801 for setting the media, a “service set-up” tab 1802 for setting the printing service, and an “operation environment” tab 1803 for setting the operation environment.

As shown in FIG. 18, the “service set-up” tab 1802 is provided with a service name display area 1802a for displaying the presence or absence of selecting the printing service, a service details display area 1802b for displaying the details of the printing service, a charge set-up area 1802c for setting the charge, a thumbnail sheet a real 802d for setting the thumbnail sheet, a receipt print area 1802e for setting the receipt print, and a “detail set-up” button 1810 for setting the details.

Then, the CPU 401 judges whether or not the “service set-up” button 1802 on the displayed environment set-up screen 1800 is selected by the input operation of the user (step S1605). If it is judged that the “service set-up” tab 1802 is not selected (step S1605: No), the process is repeated. If it is judged that the “service set-up” tab 1802 is selected (step S1605: Yes), the CPU 401 judges whether or not the “detail set-up” button 1810 of the “service set-up” tab 1802 is depressed (step S1606).

If the CPU 401 judges whether or not the “detail set-up” button 1810 is not depressed (step S1606: No), the process is repeated. If it is judged that the “detail set-up” button 1810 is depressed (step S1606: Yes), the CPU 401 displays a detail set-up screen on the display screen (step S1607). Next, the detail set-up screen for making the set-up process will be described below.

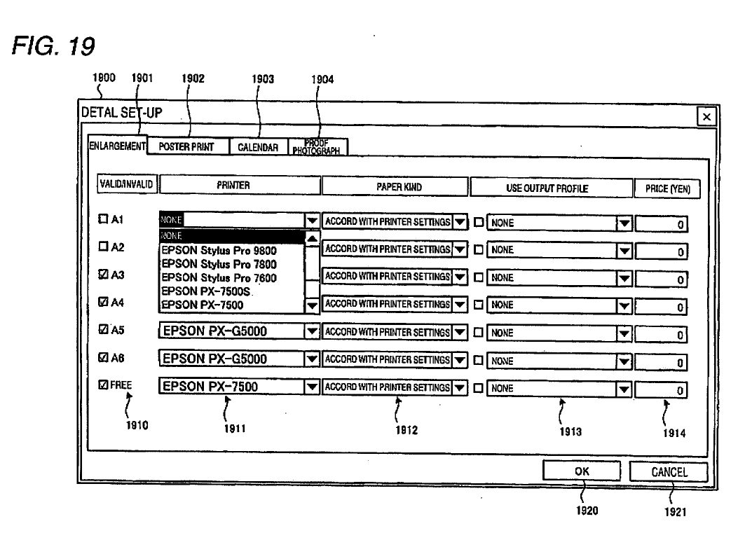

FIG. 19 is an explanatory view showing one example of the detail set-up screen for making the set-up process. In the details se-up, the printer 114 or the paper can be set up for each printing service. The detail set-up screen 1900 is provided with an “enlargement” tab 1901 for setting the details of the “enlargement” printing service, a “poster print” tab 1902 for setting the details of the “poster print” printing service, a “calendar” tab 1903 for setting the details of the “calendar” printing service, and a “certificate photograph” tab 1904 for setting the details of the “certificate photograph” printing service.

As shown in FIG. 19, the “enlargement” tab 1901 is provided with a paper setting column 1910 for setting the validity or invalidity of the applicable paper size, a printer setting column 1911 for selecting the usable printer 114, a paper kind setting column 1912 for selecting the usable paper kind, a use output profile setting column 1913 for selecting the output profile for use, and a price setting column 1914 for setting the price (yen). In the paper setting column 1910, the set-up state of the applicable paper size is known based on the presence or absence of a check mark for each radio button.

The printer 114 displayed on a pull down menu of the printer setting column 1911, the printer 114 displayed in a service details display area 1802b of the “service set-up” tab 1802 on the environment set-up screen 1800 is set up as the candidate. And the detail set-up screen 1900 is further provided with an “OK” button 1920 for permitting the application of the detail set-up, and a “cancel” button 1921 for canceling the application of the detail set-up.

Then, the CPU 401 judges whether or not the “OK” button 1920 on the displayed detail set-up screen 1900 is depressed by the input operation of the user (step S1608). If it is judged that the “OK” button 1920 is depressed (step S1608: Yes), the CPU 401 stores the information set on the detail set-up screen 1900 associated in the RAM 403 or HD 405 (step S1609).

The associated and stored information at step S1609 is the selected information in each of the setting columns 1910 to 1914 for the tabs 1901 to 1904. Also, the paper size set as valid in the paper setting column 1910 is displayed in selectable state on the paper size selection area 902 on the paper size selection screen 900.

If the CPU 401 judges that the “OK” button 1920 is not depressed (step S1608: No), the set information is stored associated at step S1609, and then the CPU judges whether or not the “cancel” button 1921 is depressed (step S1610). If it is judged that the “cancel” button 1921 is depressed (step S1610: Yes), the CPU 401 transits to step S1608 to repeat the process. If it is judged that the “cancel” button 1921 is not depressed (step S1610: No), the setting process according to this flowchart is ended. Next, the print process based on the print job created through the print condition determination process at step S707 will be described below.

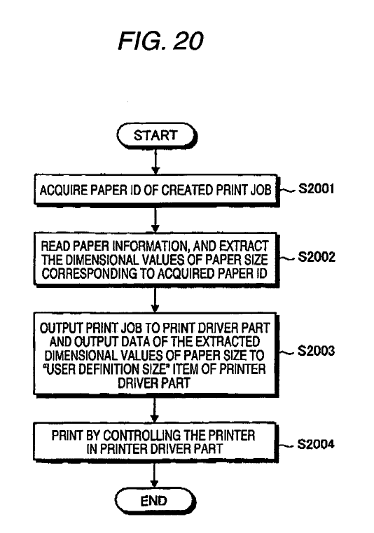

FIG. 20 is a flowchart showing one example of a print processing procedure based on the print job created through the print condition determination process at step S707. Specifically, the process as shown in FIG. 20 is performed by the application part 130 and the print driver part 140 as shown in FIG. 2, and implemented by the CPU 401 executing the print information processing program stored (recorded) in the ROM 402, RAM 403, HD 405 or optical disk 414 of the print information processing apparatus 120 as shown in FIG. 4.

First of all, the CPU 401 acquires the paper ID 524 of the print job created in the application part 130 (step S2001). Then, the application part 130 reads the paper information 320 stored in the HD 405, and extracts the dimensional values of the paper size 322 corresponding to the acquired paper ID 524 (step S2002).

And the application part 130 outputs the print job to the print driver part 140, and outputs the data of the dimensional values of the paper size 322 extracted into the “user definition size” item of the print driver part 140 (step S2003). Herein, the “user definition size” item to which data of the dimensional values output to the print driver part 140 is passed at step S2003 will be simply described below.

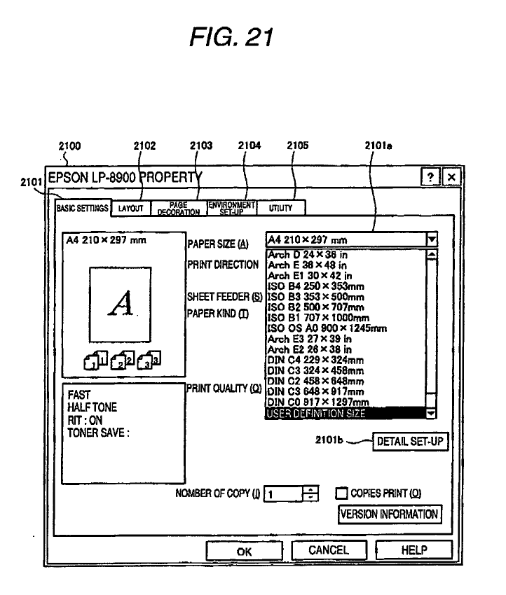

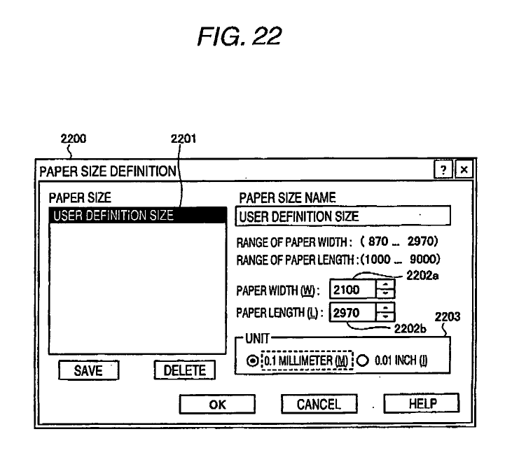

FIG. 21 is an explanatory view showing one example of a property set-up screen for the print driver part. Also, FIG. 22 is an explanatory view showing one example of a detail set-up screen for the print driver part. As shown in FIG. 21, the property set-up screen 2100 for the print driver part 140 is provided with a “basic set-up” tab 2101 for making the basic settings, a “layout” tab 2102 for setting the layout, a “page decoration” tab 2103 for making the page decoration set-up, an “environment set-up” tab 2104 for setting the environment, and a “utility” tab 2105 for setting the utility.

As shown in FIG. 21, the “basic set-up” tab 2101 is provided with a paper size selection column 2101a for selecting the usable paper size in the pull down menu, and a “detail set-up” button 2101b for setting the details of the paper size selected in the paper size selection column 2101a. Herein, the “user definition size” item is selected in the paper size setting column 2101a. And if the “detail set-up” button 2101b is depressed by the user, the detail set-up screen 2200 is displayed on the display screen of the display 408, as shown in FIG. 22.

The detail set-up screen 2200 is provided with a paper size display area 2201 for displaying the paper size selected in the paper size selection column 2101a, a numerical value input column 2202a for setting the paper width, a numerical value input column 2202b for setting the paper length, and a unit setting column 2203 for setting the unit of numerical values.

The data of the dimensional values outputted from the application part 130 to the “user definition size” column of the print driver part 140 at step S2003 is passed to the numerical value input columns 2202a and 2202b and the unit setting column 2203. Therefore, the paper size is automatically set up in the print driver part 140 only by performing the print information process including the paper size setting process in the application part 130 as described above. Thereby, the convenience of the user is improved.

And if the print job and the data of the dimensional values are outputted to the print driver part 140, the CPU 401 causes the print driver part 140 to control the printer 114 to perform the printing (step S2004). Thereby, the print process according to this flowchart is ended.

As described above, with the print information processing apparatus according to this embodiment of the invention, the paper information associated with the first identifier matched with the second identifier defining the paper size inputted by the input means is read from the storage means for storing the paper information defining the paper size and the first identifier associated with this paper information, and the paper size defining the read paper information is outputted to the print driver. Thereby, the paper size used in the print driver can be automatically set only by inputting the second identifier defining the paper size, whereby it is unnecessary for the user to perform the troublesome work such as directly inputting the dimensional values of the paper size in the print information process, and the convenience is improved. Also, the paper size defined by the paper information stored in the storage means can be utilized for the printing by inputting the second identifier defining the paper size. Therefore, the print information processing apparatus can be localized cheaply and simply without preparing the individual application for each country or district.

Also, the paper size defined by the paper information associated with the first identifier is output as the longitudinal and transversal dimensional values of the print paper used for the actual printing to the print driver. Thereby, the paper size outside the category of print paper such as regular size (A3, A4, etc.) can be set up in the print driver.

Also, when the template is acquired, the first identifier matched with the second identifier and the paper information associated with the first identifier are acquired, based on the second identifier related to the template. Thereby, the first identifier and the paper information in the storage means can be acquired only by newly acquiring the template, whereby the print information processing apparatus can be simply localized.

Also, the template related to the second identifier is acquired from an external recording medium. Thereby, the second identifier and the template can be simply acquired without altering the application, and the localization of the print information processing apparatus can be further promoted. Also, the dimensional values of the paper size are outputted for the user definition size item. Thereby, the paper size can be automatically set up in the print driver easily without the user needing to directly input the dimensional values of the paper size into the user definition size item. The set-up process for the paper size in the print information processing apparatus can be simplified.

Also, the identification information of the printable paper size on the printer is generated by the print information of the printer managed by the print driver and the paper information associated with the first identifier, whereby the selectable printer for printing is displayed on the display screen. Thereby, the paper size printable by the printer is identified, and the selectable printers are displayed on the display screen, improving the user interface (UI).

Moreover, with the print information processing method according to the invention, the paper size defined by the information concerning the paper size associated with the first identifier matched with the second identifier is outputted to the print driver. Thereby, the paper size used in the print driver can be automatically set only by inputting the second identifier defining the paper size, whereby it is unnecessary for the user to perform the troublesome work such as directly inputting the dimensional values of the paper size in the print information process, and the convenience is improved. Also, the paper size defined by the paper information associated with the first identifier matched with the second identifier can be utilized for the printing by inputting the second identifier defining the paper size, whereby the paper setting work is unnecessary for the print driver in the print information process, and the processing is simplified.

The print information processing method as described in this embodiment is implemented by executing the prepared program on the computer incorporated into the print information processing apparatus. This program is recorded in a computer readable recording medium such as a hard disk, a flexible disk, a CD-ROM, an MO or a DVD, and read and executed from the recording medium by the computer. Also, this program may be a transmission medium that can be distributed via the network such as the Internet.

What is claimed is:

1. A print information processing apparatus for printing the image data, and having an application for setting the paper size of the paper on which said image data is printed, comprising:
a storage part for storing the paper information defining said paper size and a first identifier corresponding to said paper information;
an input part for inputting a second identifier corresponding to said paper information; and
an information setting part for reading said paper information associated with said first identifier matched with said second identifier from said storage part, based on said second identifier inputted by said input part, and outputting said paper size defined by said paper information.

2. The print information processing apparatus according to claim 1, further comprising a print driver, in which said information setting part outputs said paper size defined by said paper information to said print driver, and said paper size defined by said paper information is longitudinal and transversal dimensional values of said paper on which said image data is printed.

3. The print information processing apparatus according to claim 1, further comprising a template acquisition part containing a third identifier corresponding to said paper information and storing a template of making a predetermined processing on said image data in the storage part, and a paper information acquisition part for storing the paper information associated with said third identifier as the paper information associated with said first identifier in the storage part with said third identifier contained in said template as said first identifier.

4. The print information processing apparatus according to claim 3, further comprising a display control part for displaying the template containing said third identifier matched with said second identifier on a display screen based on said second identifier inputted by said input part.

5. The print information processing apparatus according to claim 3, wherein said template acquisition part acquires said template from an external storage medium.

6. The print information processing apparatus according to claim 2, wherein said print driver sets up said paper size of said paper on which said image data is printed, based on said dimensional values of said paper size outputted from said information setting part.

7. The print information processing apparatus according to claim 2, further comprising an identification information generation part for acquiring the print information of a printer managed by said print driver and generating the identification information of said paper size printable on said printer, based on said acquired print information and said paper information associated with said first identifier, and a display control part for displaying said selectable printer for printing on the display screen, using said identification information generated by said identification information generation part.

8. A print information processing method, comprising:
inputting a second identifier corresponding to the paper information defining the paper size of the paper on which said image data is printed in printing the image data; and
outputting said paper size defined by said paper information corresponding to a first identifier matched with said second identifier to a print driver, based on said input second identifier.

9. A print information processing program for enabling a computer to perform the print information processing method according to claim 8.
